(19) United States
(12) Patent Application Publication
(10) Pub. No.: US 2015/0357649 A1
(43) Pub. Date: Dec. 10, 2015

(54) BATTERY AND METHOD OF ASSEMBLING SAME

(71) Applicant: The Aerospace Corporation, El Segundo, CA (US)

(72) Inventors: Gouri RADHAKRISHNAN, Rancho Palos Verdes, CA (US); Michael V. QUINZIO, Santa Monica, CA (US)

(21) Appl. No.: 14/296,824

(22) Filed: Jun. 5, 2014

(51) Int. Cl. H01M 4/66; H01M 4/1395; H01M 4/46; H01M 4/04; H01M 10/052; H01M 4/38

(52) U.S. Cl. CPC H01M 4/667; H01M 10/052; H01M 4/663; H01M 4/38; H01M 4/463; H01M 4/0402; H01M 4/1395; H01M 2220/20

(57) ABSTRACT

A battery is provided with a special form of conductive substrate that does not include the use of a conventional metal such that the overall weight of the battery is substantially reduced. Instead, the battery, such as the anode portion of the battery, includes a conductive base substrate made from a non-metallic, electrically conductive material. A coating material is deposited onto the base substrate, wherein the coating material includes at least one active material that is directly applied onto the base substrate.

### BACKGROUND

The embodiments described herein relate generally to systems configured to supply and receive electric power during operation and, more particularly, to a battery.

At least some known systems, such as satellite systems or electric vehicle systems, supply and/or receive an energy flow during operation. For example, at least some known satellite components receive electrical energy from a battery. Similarly, at least some known electric vehicles receive electrical energy from a battery.

A known class of batteries are lithium-based batteries that each include an electrode having a metal substrate to receive or hold active materials. The metal substrate is electrically conductive and is configured to be a current collector during electrochemical cycling. However, metal substrates and provisions for supporting them have a significant weight, thereby causing the metal substrates and the batteries that employ them to be heavy. For example, a metal substrate can have a diameter of 15 millimeters (mm) and a weight that ranges for 0.02 gram (g) to 0.2 g. Such a weight can limit the various applications of the battery for known systems. For example, in some embodiments, this additional weight can limit the various applications of the battery by lowering the specific energy (Wh/kg).

### BRIEF DESCRIPTION

In one embodiment, a battery is provided with a special form of conductive substrate that does not include the use of a conventional metal such that the overall weight of the battery is substantially reduced. Instead, the battery, such as the anode portion of the battery, includes a conductive base substrate made from a non-metallic, electrically conductive material. A coating material is deposited onto the base substrate, wherein the coating material includes at least one active material that is directly applied onto the base substrate. As such, this coating material can act as the electrochemically active material and can intercalate lithium ions (Li⁺) when the cell is being charged and delithiate on discharge.

In another embodiment, a system is provided. The system includes a device that is configured to receive an energy flow during operation. The system also includes a battery that is coupled to the device and the battery is configured to provide the energy flow to the device. The battery includes a conductive base substrate made from a non-metallic, electrically conductive material. A coating material is deposited onto the base substrate, wherein the coating material includes at least one active material that is directly applied onto the base substrate. As such, this coating material can act as the electrochemically active material and can intercalate Li⁺ ions when the cell is being charged and delithiate on discharge.

In yet another embodiment, a method of assembling a battery is provided. The method includes providing a conductive base substrate that includes a non-metal electrically conductive material. A coating material that includes at least one active material is deposited directly onto the base substrate. This coating material will act as the electrochemically active material and will intercalate Li+ ions when the cell is being charged and delithiate on discharge.

### BRIEF DESCRIPTION OF THE DRAWINGS

FIG. 1 is a block diagram of an exemplary system that includes at least one device and a battery;

FIG. 2 is a cross-sectional view of a portion of the battery shown in FIG. 1 and taken from area 2;

FIG. 3 is a flow diagram of an exemplary method of assembling the battery shown in FIGS. 1 and 2; and

FIGS. 4A and 4B are exemplary graphical outputs illustrating characteristics of the battery shown in FIGS. 1 and 2.

### DETAILED DESCRIPTION

The embodiments described herein include a battery that does not include the use of known metal substrates. Instead, the battery includes an electrically conductive non-metal base substrate that includes one or more layers of a crystalline carbon material. For example, in some embodiments, multiple layers of a crystalline carbon material, such as Graphene is used. Graphene is an atomic layer of carbon and a crystalline allotrope of carbon. In some embodiments, multiple layers of the crystalline carbon material facilitate an increase to the surface area.

In certain embodiments, a coating material is applied onto a crystalline carbon base substrate, wherein the coating material includes at least one active material. The active material can be directly deposited onto at least a portion of the base substrate via a direct deposition process such that no binders are needed. By using a non-metal base substrate, such as graphene foam, instead of a metal substrate, the weight of the battery is substantially reduced in comparison to known batteries comprising metallic bases and metals for most or all the electrically and/or thermally conductive components of the battery. Omitting binders as part of the battery also helps to reduce the overall weight of the battery.

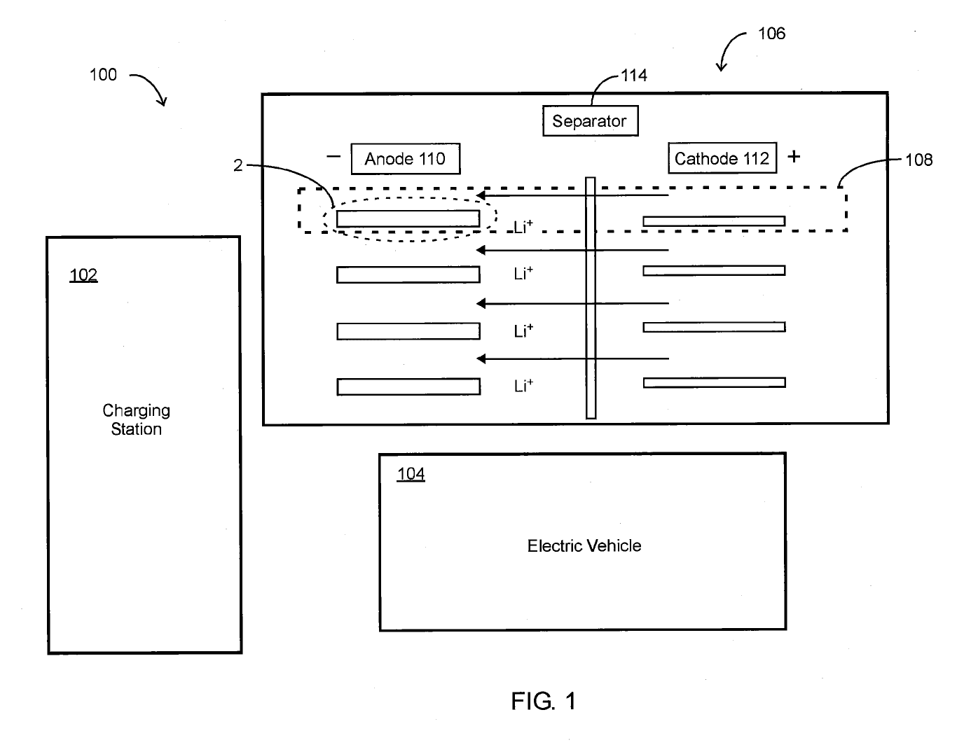

FIG. 1 illustrates a system 100 for facilitating the use and maintenance of electric vehicles, as described below. While the exemplary embodiment illustrates a system for electric vehicles, the present disclosure is not limited to such systems and one of ordinary skill in the art will appreciate that the disclosed techniques may be used in conjunction with other types of apparatus that require batteries, especially lithium-ion batteries, and various types of batteries, per se. For example, in some embodiments, system 100 can be a satellite system used for space communications and the satellite system can include devices that include the use of batteries.

In some embodiments, system 100 includes a charging station 102 and at least one electric vehicle 104. It should be noted that the term “electric vehicle” refers generally to a vehicle that includes one or more actuators used for positioning or propulsion, such as electric motors. Energy used to propel electric vehicle 104 may come from various sources, such as, but not limited to, an on-board rechargeable battery, such as battery 106, and/or an on-board fuel cell. For example, in some embodiments, electric vehicle 104 can be a fuel-cell vehicle, which uses only electrical energy for propulsion. Alternatively, electric vehicle 104 can be a hybrid electric vehicle, a hydrocarbon reaction fuel-cell vehicle, or any other vehicle to which electrical energy can be delivered, for example, for charging from a power grid. In regenerative embodiments, electric vehicle 104 can capture and store energy generated by braking. Moreover, electric vehicle 104 can use energy stored in an electrical source, such as battery 106, to continue operating on battery power to conserve fuel, rather than idling the motor. In some embodiments, electric vehicle 104 is capable of recharging battery 106 by plugging into a power receptacle, such as a general power outlet, located within charging station 102.

In some embodiments, battery 106 is coupled to electric vehicle 104 such that battery 106 is at least partially housed within a portion of electric vehicle 104, and arranged such that battery 106 provides electric current at an operational voltage level to electric vehicle 104. It should be noted that, as used herein, the term “couple” is not limited to a direct mechanical, thermal, communication, and/or an electrical connection between components, but may also include an indirect mechanical, thermal, communication and/or electrical connection between multiple components, e.g., through switches, proportional control circuits, signaling arrangements or other intervening elements.

In some embodiments, battery 106 can be a rechargeable lithium-ion battery that includes one or more electrochemical cells 108 that convert stored chemical energy into electrical energy. Alternatively, battery 106 can be any other lithium-based battery or any other type of battery that enables electric vehicle 104 to operate. Each electrochemical cell 108 can have any suitable shape that enables battery 106 to function as described herein. For example, electrochemical cell 108 take the form of a disk, cylinder, or be prismatic. In other embodiments, electrochemical cell 108 can take the form of a cube or rectangle.

Each electrochemical cell 108 includes a negative terminal or anode 110 and a positive terminal or cathode 112, and a separator 114 therebetween. Electrolytes (not shown) enable ions to move between anode 110 and cathode 112, which supplies current to flow out of battery 106 at a potential difference, to perform work, such as facilitating the operation of electric vehicle 104. As described in more detail below with respect to the remaining figures, battery 106 is configured to minimize or wholly omit the use of metal elements in the substrate. Instead of metal elements, battery 106 includes a non-metal conductive base substrate (not shown in FIG. 1) such that the overall weight of battery 106 is correspondingly reduced in comparison to at least some comparable batteries that use metals for such elements.

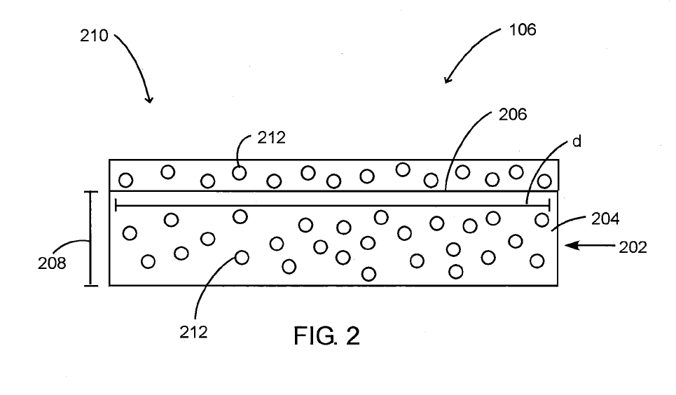

FIG. 2 is a cross-sectional view of a portion of battery 106 taken from area 2 (shown in FIG. 1). Each cell 108 (shown in FIG. 1) of battery 106 includes at least one conductive base substrate 202 that is at least partially positioned within anode 110 (shown in FIG. 1) and/or cathode 112 (shown in FIG. 1). Conductive base substrate 202 is configured to be an electrode to collect current during the electrochemical cycling process. In some embodiments, conductive base substrate 202 is composed of a crystalline carbon material, such as a graphene foam 204.

Base substrate 202 can have any suitable shape that enables battery 106 to function as described herein. For example, in some embodiments, base substrate 202 can take the form of a disk shape such that a surface 206 of base substrate 202 is circular. In some embodiments, the diameter (d) of base substrate 202 can be 15 mm, as in a standard 2032 coin cell. The dimensions of the base substrate can range from 15 mm in a standard coin cell to 10 inches by 30 feet in a cylindrical cell. Base substrate 202 can also have a thickness 208 of 0.3 nanometers for a single atomic layer of carbon up to 25 micrometers for multiple layers and a density that varies with respect to thickness and porosity of the graphene foam. For example, in some embodiments, the density can be in the range of 2 to 8 milligrams per centimeter³ (mg/cm³). In some embodiments, base substrate 202 can be composed of a porous material. For example, in some embodiments, graphene foam 204 includes multiple layers of graphene separated by pores (not shown). In some embodiments, graphene foam 204 of base substrate 202 includes pores that have an average pore size of 580 microns or as determined by the porosity of the template used to prepare the foam.

In some embodiments a base substrate 202 having exposed graphene foam 204 may be unsuitable as a working electrode for battery 106, e.g., being prone to disintegrate within a short time of use. In that case, a coating material 210 can be applied onto at least a portion of the base substrate 202, such as on the surfaces, such as on surface 206, of base substrate 202. In some embodiments, coating material 210 is applied onto the entire base substrate 202. In some embodiments, coating material 210 includes a silicon coating material that can be deposited directly onto base substrate 202. The deposition process is explained in more detail below with respect to the remaining figures.

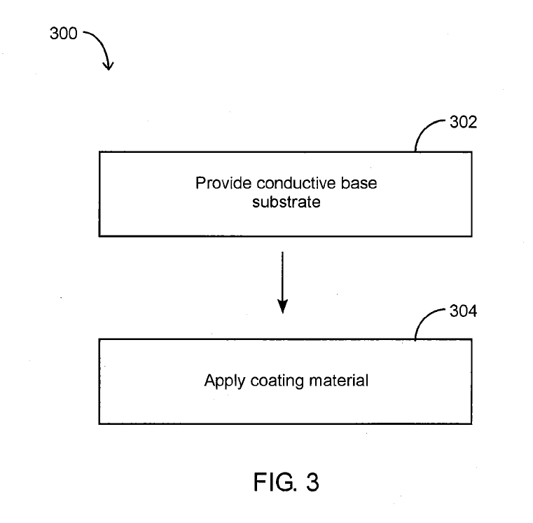

In some embodiments, coating material 210 includes at least one active material 212 that can be applied directly onto the base substrate 202 such that active material 212 is applied onto the base substrate 202. In some embodiments, the active material 212 can be on the surface and also penetrate into the bulk of the base substrate. In some embodiments, active material 212 can include any suitable component that enables battery 106 to function as described herein, including but not limited to metal. For example, in some embodiments, silicon, germanium, tin, tungsten bronze, iron, aluminum, gold, silver, cobalt, nickel, manganese, sulfur, and/or molybdenum can be used. In some embodiments, active material 212 can be applied directly onto base substrate 202 such that no binders are needed. In some embodiments, binders are needed when the active material is a powder or a slurry that needs to be bonded onto the substrate 202 and will not bond directly. The binder acts as a glue. In some embodiments, active material 212 can be directly deposited onto at least a portion of base substrate 202 via a direct deposition process such that no binders are needed. For example, the process described in more detail below with respect to FIG. 3 uses the direct deposition of material 212 on the substrate 202 as opposed to bonding a powder to the substrate 202.

By using base substrate 202 composed of graphene foam 204 instead of a metal-based substrate, the overall weight of battery 106 is substantially reduced. More specifically, the weight of commonly used metal substrates, such as copper or other types of metal foams, can weigh a factor of 10-200 more than the graphene foam 204. For example, a metal electrode having a diameter of 15 mm can weigh in the range of 0.02 g to 0.2 g or 20 mg to 200 mg. In contrast, graphene foam 204 having the same diameter can weigh in the range of 0.00013 g to 0.0013 g or 1.3 mg to 13 mg. Table 1 below provides a comparison of weights of different types of substrates that are each in the form of a disc and that each have a diameter of 15 mm. Table 1 also includes the weight of the silicon coating material 210 that can be deposited onto graphene foam 204.

TABLE 1
Weight of different substrates

| Material | Weight (mg) |
|---|---|
| Copper (thickness 25 | 40 |
| μm) | |
| Nickel Foil (thickness | 15 |
| 10 μm) | |
| Porous Nickel Foam | 200 |
| (thickness 1.6 mm) | |
| Porous Graphene Foam | 1.3 |
| (thickness 1.2 mm) | |
| Pulse Laser Deposited | 0.2-0.4 |
| Silicon (thickness 200- | |
| 400 nm) | |

As such, by replacing a metal substrate with base substrate 202, a reduction in the weight of cell 108 and the overall weight of battery 106 results. In various applications, the weight reduction is sufficient to make the system employing the battery feasible and practical, whereas a heavier battery would not.

FIG. 3 is a flow diagram 300 of an exemplary method of assembling a battery, such as battery 106 (shown in FIGS. 1 and 2). In step 302, a conductive base substrate, such as base substrate 202 (shown in FIG. 2) that includes a crystalline carbon material, such as graphene foam 204 (shown in FIG. 2), is provided. In some embodiments, graphene foam 204 can be fabricated to the specifications described above using a variety of fabrication and manufacturing processes known in the art, such as, but not limited to, etching away a metal template after depositing multilayer graphene Alternatively, in some embodiments, graphene foam 204 can be purchased, such as any suitable commercially available graphene foam having the specifications described above.

In step 304, a coating material, such as silicon coating material 210 (shown in FIG. 2) having at least one active material 212 (shown in FIG. 2) is applied onto at least a portion of base substrate 202, such as on at least surface 206 (shown in FIG. 2) of base substrate 202. Silicon coating material 210 having active material 212 can be directly applied onto base substrate 202 using any suitable process known in the art, such as a known pulsed laser deposition (PLD) process. In some embodiments, the PLD process uses laser pulses that are directed onto base substrate 202 at a suitable wavelength, with a suitable fluence and frequency. For example, base substrate 202 can be mounted onto a holder (not shown) and positioned into a vacuum chamber (not shown) having a suitable pressure, such as less than 1×10⁻⁷ torr or in a gaseous ambient with pressures of 2 torr or less. A commercially available crystalline silicon target can be ablated using, for example, a Krypton fluoride (KrF) laser having radiation at 248 nanometers (nm), with a fluence of 15-16 Joules per centimeter² (J/cm²) and a full width at half-maximum (FWHM) pulse duration of 25 nanoseconds (ns). The ablations can be conducted at room temperature. A repetition rate of 20 Hertz (Hz) can be used for varying times to attain different weights of silicon. An estimated rate of deposition can be 0.04 μg/laser pulse. Alternative known deposition techniques can be used, such as a known gas phase chemical vapor deposition. Using the gas phase chemical vapor deposition can further improve the performance by enabling enhanced access of the surface 206 and also to beneath the surface bulk of the base substrate 202 and, therefore, provide a relatively larger surface area for the active material. In other embodiments, a known liquid phase deposition process can be used.

Battery 106 using substrate 202 can withstand and endure multiple electrochemical cycles. In some embodiments, as shown in the experiment below, battery 106 can be tested by performing multiple electrochemical cycles to identify how substrate 202 will endure during the cycles.

### Experiment

In one embodiment, a battery such as battery 110, was used on an anode portion of two different cells, such as anode 110 (shown in FIG. 1) of electrochemical cell 108 (shown in FIG. 1). The anodes were then tested by cycling the electrode in a half-cell configuration versus lithium metal using 1M LiPF₆ in 1:1 ethylene carbonate/diethyl carbonate (EC/DEC) electrolyte. Galvanostatic cycling and cyclic voltammetry were performed using Keithley 2400 Source Meters and an Arbin BT2000 cycler. After cycling, cells were discharged before opening, and the anodes were rinsed in DEC and vacuum dried prior to post cycling characterization.

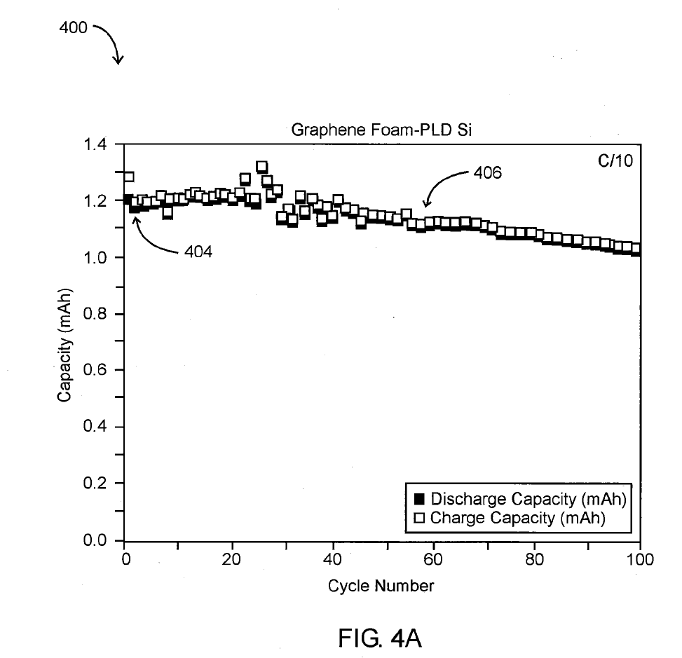

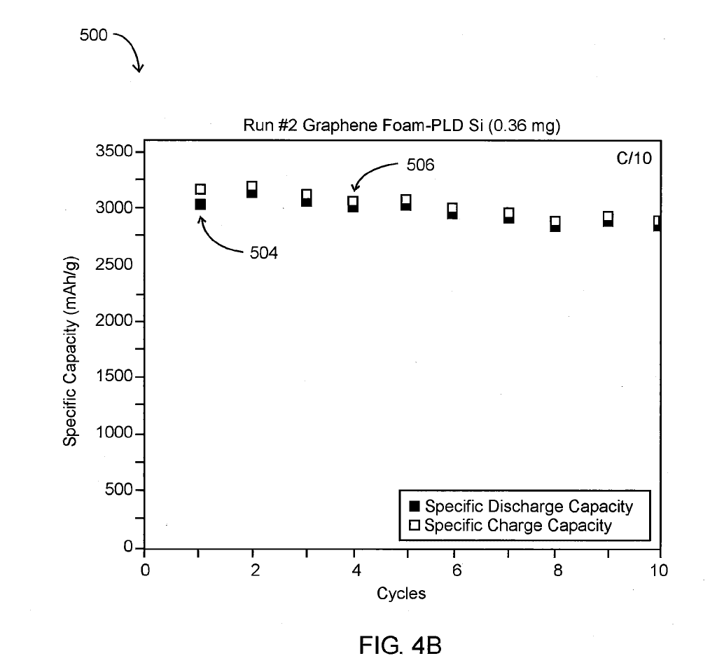

As shown in FIGS. 4A and 4B, the results of this test showed that the graphene foam with deposited silicon, such as graphene foam 204 with deposited silicon (shown in FIG. 2) can endure multiple cycles. For example, FIG. 4A illustrates a graphical output 400 of test results for one of the graphene foams with deposited silicon on a first anode that was cycled at a C/10 charge rate. Output 400 includes capacity in units milliampere-hour (mAh) on the y-axis versus the cycle number on the x-axis. Output 400 illustrates discharge capacity 404 in mAh and charge capacity 406 in mAh during the cycles. As illustrated in FIG. 4A, there was a mere 20% loss after 100 cycles.

FIG. 4B illustrates a graphical output 500 of test results for one of the graphene foams with deposited silicon on a second anode that was tested and its data was used to compute an average specific capacity of 2778 mAh/g at a C/10 charge rate (per weight of silicon). Output 500 includes the specific capacity in units mAh/g on the y-axis versus the cycle number on the x-axis. Output 500 illustrates a specific discharge capacity 504 in mAh/g and a specific charge capacity 506. As illustrated in FIG. 4B, the results were similar to the results shown in output 400 (shown in FIG. 4A) in that the loss was again minimal.

As compared to known batteries, the embodiments of the battery described herein is substantially reduced in the overall weight because the battery does not include the use of a metal substrate. Instead, the battery includes an electrically conductive non-metal base substrate that includes a crystalline carbon material, such as graphene. Graphene is a single atomic layer of carbon and a crystalline allotrope of carbon. In certain embodiments, a coating material is applied onto a crystalline carbon base substrate. At least one active material can be directly deposited onto the base substrate via a direct deposition process such that no binders are needed. By using a non-metal base substrate, such as graphene foam, instead of a metal substrate, the weight of the battery is substantially reduced in comparison to known batteries comprising metallic bases and metals for most or all the electrically and/or thermally conductive components of the battery. Having no binders as part of the battery also helps to reduce the overall weight of the battery.

Exemplary embodiments of the systems, and methods are described above in detail. The systems, battery, and methods are not limited to the specific embodiments described herein, but rather, components of the systems, battery and/or steps of the method may be utilized independently and separately from other components and/or steps described herein. For example, the battery may also be used in combination with other systems and methods, and is not limited to practice with only a system as described herein. Rather, the exemplary embodiment can be implemented and utilized in connection with many other systems.

Although specific features of various embodiments of the disclosure may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A battery comprising:
a conductive base substrate comprising a non-metal electrically conductive material; and
a coating material applied onto at least a portion of said base substrate, wherein said coating material comprises at least one active material that is directly applied onto at least a portion of said base substrate.

2. The battery in accordance with claim 1, wherein said non-metal electrically conductive material comprises crystalline carbon.

3. The battery in accordance with claim 2, wherein said crystalline carbon material comprises a graphene foam.

4. The battery in accordance with claim 3, wherein said graphene foam comprises a thickness in the range of 0.3 nanometers to 25 micrometers.

5. The battery in accordance with claim 3, wherein said graphene foam comprises a porous graphene foam having an average pore size of 580 microns.

6. The battery in accordance with claim 1, wherein said at least one active material comprises at least one type of component comprising at least one of silicon, germanium, tin, tungsten bronze, iron, aluminum, gold, silver, cobalt, nickel, manganese, sulfur, or molybdenum.

7. The battery in accordance with claim 1, wherein said coating material further comprises silicon.

8. The battery in accordance with claim 1, further comprising an anode portion, wherein said conductive base substrate is configured to be at least partially positioned within said anode portion.

9. The battery in accordance with claim 1, further comprising a cathode portion, wherein said conductive base substrate is configured to be at least partially positioned within said cathode portion.

10. A system comprising:
a device configured to receive an energy flow during operation; and
a battery coupled to said device and configured to provide the energy flow to said device, said battery comprising:
a conductive base substrate comprising a non-metal electrically conductive material; and
a coating material applied onto said base substrate, wherein said coating material comprises at least one active material that is directly applied onto at least a portion of said base substrate.

11. The system in accordance with claim 10, wherein said non-metal electrically conductive material comprises crystalline carbon.

12. The system in accordance with claim 10, wherein said crystalline carbon material comprises a graphene foam.

13. The system in accordance with claim 12, wherein said graphene foam comprises a porous graphene foam comprising a thickness in the range of 0.3 nanometers to 25 micrometers and an average pore size of 580 microns.

14. The system in accordance with claim 10, wherein said at least one active material comprises at least one type of component comprising at least one of silicon, germanium, tin, tungsten bronze, iron, aluminum, gold, silver, cobalt, nickel, manganese, sulfur, or molybdenum.

15. The system in accordance with claim 10, wherein said coating material further comprises silicon.

16. The system in accordance with claim 10, wherein said battery further comprises an anode portion, said conductive base substrate is configured to be at least partially positioned within said anode portion.

17. The system in accordance with claim 10, wherein said battery further comprises a cathode portion, said conductive base substrate is configured to be at least partially positioned within said cathode portion.

18. A method of assembling a battery, said method comprising:
providing a conductive base substrate that includes a non-metal electrically conductive material; and
applying a coating material that includes at least one active material onto at least a portion of the base substrate such that the at least one active material is directly applied onto at least a portion of the base substrate and the coating material.

19. The method in accordance with claim 18, wherein providing a conductive base substrate comprises providing a conductive base substrate that includes a non-metal electrically conductive material including crystalline carbon.

20. The method in accordance with claim 18, wherein providing a conductive base substrate comprises providing a conductive base substrate that includes a porous graphene foam.

21. The method in accordance with claim 18, wherein applying a coating material comprises applying a coating material that includes at least one type of component that includes at least one of silicon, germanium, tin, tungsten bronze, iron, aluminum, gold, silver, cobalt, nickel, manganese, sulfur, or molybdenum.

22. The method in accordance with claim 18, wherein applying a coating material comprises applying a silicon coating.

23. The method in accordance with claim 22, wherein applying a silicon coating comprises applying a silicon coating via a pulsed laser deposition process or a gas phase deposition process.
